(19) United States
(12) Patent Application Publication
(10) Pub. No.: US 2024/0009936 A1
(43) Pub. Date: Jan. 11, 2024

(54) SYSTEMS AND METHODS OF MANUFACTURING CONTAINERS FROM POLYMERIC MATERIALS WITH UNWARPED INTERNAL PARTITION

(71) Applicant: PLASGAD PLASTIC PRODUCTS ACS LTD, Upper galilee (IL)

(72) Inventor: IFTAH PORAN, Ramat Ha Golan (IL)

(73) Assignee: PLASGAD PLASTIC PRODUCTS ACS LTD, Upper galilee (IL)

(21) Appl. No.: 18/217,767

(22) Filed: Jul. 3, 2023

(30) Foreign Application Priority Data
Jul. 6, 2022 (IL) 294569

(51) Int. Cl. B29C 65/08; B65D 25/04; B65D 6/00; B65D 6/34

(52) U.S. Cl. CPC B29C 65/08; B65D 25/04; B65D 11/10; B65D 11/26

(57) ABSTRACT

A process of manufacturing containers from polymeric materials with unwarped internal partition is described; a container with unwarped internal partition, manufactured from polymeric materials and a system for manufacturing containers with unwarped internal partition from polymeric materials, are further described; the process comprises: premanufacturing a bottom part of a container, premanufacturing a top part of the container, applying a preheating treatment, appending the top part of the container, welding, cooling down the welded complex of the container; the container comprises: a bottom part, a top part comprising a bottom plate, surrounding sidewalls and at least one interior partition; the system comprises: at least one first premanufacturing subsystem, at least one second premanufacturing subsystem, at least one preheater, an appending mechanism, a welding machine and a cooler.

### TECHNICAL FIELD

In general, the present invention pertains to the art of plastic manufacture. In particular, the invention relates to systems and methods of manufacturing containers from polymeric materials with unwarped internal partition.

### BACKGROUND ART

Warpage is one of the common quality issues in plastic injection molding. This defect is when there is an excessive distortion of a part after ejection which deviates significantly from the injection mold cavity.

It is believed that the current state of the art is represented by the following patent literature: U.S. Pat. No. 2,378,801 and US2005155324.

US2005155324 that is believed to represent the closest prior art discloses a system of sealing containers of plastic material for the sealing of containers having a mouth surrounded by a peripheral flap, consisting of arranging a sealing sheet on the mouth of the container to be sealed, supporting the peripheral flap on a welding mold, and applying ultrasonic vibrations on the sealing sheet, in coincidence with a mold, by means of independent sonotrodes, the mold comprising two concentric walls situated in coincidence with the peripheral flap surrounding the mouth of the container to be sealed, an internal wall allowing for the welding between the sealing sheet and the peripheral flap of the mouth, and another outer wall, of a slightly larger height, finished in an angled edge profile to cause the cutting of the sealing sheet and of said peripheral flap at a certain variable distance from the weld line between said sheet and peripheral flap.

Warpage of plastic parts according to U.S. Pat. No. 7,666,335B is a result of variations in shrinkage within the part as it is being formed. These variations in shrinkage have generally been attributed to side-to-side variations in mold temperature, anisotropic shrinkage variations resulting from flow induced polymer and filler orientation, and global shrinkage variations (shrinkage variations between regions of a part) resulting from differences in wall thickness, mold temperature, melt temperature and melt pressure.

Warpage is one of the problems during the printing process of polymeric objects by 3D printer. The printed part experiences cycles of heating and cooling as melt layers are deposited on the cooled layers inducing thermal gradient within the parts causing problems such as shrinkage and warpage that may lead to dimensional inaccuracy. Warpage occurs due to uneven heat distribution causing internal stress within printed object parts, which result in curling of the sample when it cools down after printing. Some 3D printers include a heated print bed to ease this problem. The heated print bed heats the build plate and ensures the bottom layers of the printed object are kept warm as more layers are added. Therefore, the object is being cooled evenly and thermal contraction at the base of the part decreased.

### SUMMARY OF THE INVENTION

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

It is an object of the present invention to provide a process of manufacturing containers by welding a polymeric top part to a bottom part. The manufacturing method allows to overcome technical problem of warpage of the interior partition of the top polymeric part, after the coiling step of the welded complex of the container.

In some embodiments of the manufacturing process presented herein, a heat source was used for preheating the bottom part prior to the step of ultrasonic welding. The step of preheating the bottom part has proved to prevent warpage of the in internal monolithic partition, which has occurred after applying ultrasonic welding followed by a step of cooling, in the containers welded without preheating of the bottom part. Any suitable heat source, such as: electrical, optical, etc., can be used

In some embodiments of the manufacturing method presented herein, the unexpected experimental result of the preheating step has been the undefaced polymer container with a flat and straightened or otherwise unwarped internal partition in the top part of the container, after ultrasonic welding, coiling and retrieval.

This is as opposed to the common manufacturing processes that are performed without preheating, which resulted in a warped and non-straight or buckled internal partition in the top part of the container, sometime after the ultrasonic welding, coiling and retrieval.

In accordance with some aspects and embodiments of the invention, there is provided a process of manufacturing containers from polymeric materials with unwarped internal partition including: premanufacturing a bottom part of a container from a polymeric material, in which the bottom part embodying essentially a platform shape; premanufacturing a top part of the container from a polymeric material, in which the top part including: a bottom plate of the top part, configured to match the bottom part, in which a superior surface of the bottom part is engageable to an inferior surface of the bottom plate of the top part; a plurality of surrounding sidewalls, in which an interior profile of the surrounding sidewalls is configured to match an exterior profile of the bottom part; at least one interior partition, configured for dividing an interior volume of the container into at least two distinct compartments, in which the interior partition extends essentially an entire distance in-between two opposing sidewalls, of the plurality of surrounding sidewalls, in which the interior partition forms an integral monolithic part of the plurality of surrounding sidewalls; applying a preheating treatment to the bottom part; appending the top part of the container to the first bottom part following the step of applying the preheating; welding the interior profile of the surrounding sidewalls of the top part with the exterior profile of the bottom part, thereby forming a welded complex of the container; cooling down the welded complex of the container, thereby facilitating stretching of the at least one interior partition and forming of a container with an unwarped internal partition.

In some embodiments, the manufacturing process further includes, after the premanufacturing of the bottom part and the top part, transferring the bottom part and the top part by at least one transportation mechanism selected from a group of: a conveyor, robotic arm, mobile robot, railed vehicle, aerial vehicle and marine vessel.

In some embodiments, the interior profile of the surrounding sidewalls is configured to overlap with the exterior profile of the bottom part.

In some embodiments, the welding includes an ultrasonic welding.

In accordance with some aspects and embodiments of the invention, there is provided a container with unwarped internal partition, manufactured from polymeric materials, the container includes: a bottom part of the container, in which the bottom part embodying essentially a platform shape; a top part of the container, in which the top part including: a bottom plate of the top part, configured to match the bottom part, in which a superior surface of the bottom part is engageable to an inferior surface of the bottom plate of the top part; a plurality of surrounding sidewalls, in which an interior profile of the surrounding sidewalls is configured to match an exterior profile of the bottom part; at least one interior partition, configured for dividing an interior volume of the container into at least two distinct compartments, in which the interior partition extends essentially an entire distance in-between two opposing sidewalls, of the plurality of surrounding sidewalls, in which the interior partition forms an integral monolithic part of the plurality of surrounding sidewalls; the container is being manufactured by performing the steps of: premanufacturing the bottom part from a polymeric material; premanufacturing the top part from a polymeric material; applying a preheating treatment to the bottom part; appending the top part of the container to the first bottom part following the step of applying the preheating; welding the interior profile of the surrounding sidewalls of the top part with the exterior profile of the bottom part, thereby forming a welded complex of the container; cooling down the welded complex of the container, thereby facilitating stretching of the at least one interior partition and forming of a container with an unwarped internal partition.

In some embodiments, in which the container includes a plurality of interior monocytic partitions.

In some embodiments, in which the container is of at least one configuration selected from the group consisting of: an open top configuration, closed configuration, open side configuration and open front configuration.

In some embodiments, in which the polymeric materials of the bottom part and the top part are a thermoplastic resin.

In some embodiments, in which the container includes a plurality of interior monocytic partitions, in which at least one partition of the plurality of the monocytic partitions is disposed essentially orthogonally to at least one another partition of the plurality of the monocytic partitions.

In some embodiments, in which the bottom part includes at least one structural element configured for manipulating and/or conveying the container, in which the at least one structural element is selected from the group consisting of: a notch, groove, recess, ridge, wheels.

In some embodiments, in which at least one the surrounding sidewalls includes at least one element selected from the group of: a handle, a tab-shaped handhole, a preparation for a handhole.

In some embodiments, in which the surrounding sidewalls comprise peripheral rim.

In some embodiments, in which a superior surface of the bottom part comprise a structured shape configured for engaging to inferior surface of an inferior surface of the bottom plate of the top part.

In some embodiments, in which the bottom part includes at least one structural element selected from the group consisting of: a plurality of reinforcement ribs, plurality of circular ridges and plurality of polygonal ridges.

In some embodiments, in which a superior surface of the bottom plate of the top part includes at least one structural element configured for affixing articles in the container.

In some embodiments, in which the container further includes a lid, in which the lid is attachable to the surrounding sidewalls by at least one mechanism selected from the group of: an interlocking mechanism, snap-on mechanism and hinged mechanism. A system for manufacturing containers with unwarped internal partition from polymeric materials includes: at least one first premanufacturing subsystem, including at least one mold embodying an inverted shape of a bottom part of the container; at least one second premanufacturing subsystem, including at least one member selected from the group consisting of: a mold embodying an inverted shape of a top part of the container and an extruder nozzle including a profile of a shape the top part of the container; in which the at least one member further includes: a void volume of an inverted shape of surrounding sidewalls, in which an interior profile of the surrounding sidewalls essentially matching an exterior profile of the bottom plate; a void volume of an inverted shape of at least one monolithic interior partition, configured for dividing an interior volume of the container into at least two distinct compartments; in which the interior partition extends essentially an entire distance in-between two opposing sidewalls, of the surrounding sidewalls; in which the void volume of the inverted shape of the at least one interior partition forms a continuum with the void volume of the inverted shape of the surrounding sidewalls; at least one preheater, configured to apply preheating treatment to the bottom part; an appending mechanism configured appending the top part of the container to a preheated bottom part; a welding machine, configured for fusing a bottom edge of the top part with a top edge of the bottom part, thereby forming a welded complex of the container; a cooler configured for cooling down the welded complex of the container, thereby stretching the at least one interior partition and facilitating forming of a container with an unwarped internal partition.

### Technical Problem

The technical problem underlying the present invention is the occurrence of warpage in an interior partition of a two-part container, including a premanufactured top part with a monolithic interior partition and a premanufactured bottom plate part, manufactured from polymeric materials and connected by a means of welding the top part onto the bottom part.

A characteristic of products manufactured from plastic polymers is that the internal stress often causes the buckling and/or deformation of the plastic part, otherwise known as the warpage of the manufactured plastic products. The warpage adversely affects the product in terms of quality and uniformity of the polymeric parts, particularly of two-part containers, including a premanufactured top part with a monolithic interior partition.

Therefore a solution for the technical problem of manufacturing two-part containers from polymeric materials, from a premanufactured top part with a monolithic interior partition and a premanufactured bottom plate part, with unwarped internal partition of the top part, is called for.

It is an object of the present invention to provide a process of manufacturing containers by welding a polymeric top part to a bottom part. The manufacturing method allows to overcome technical problem of warpage of the interior partition of the top polymeric part, after the coiling step of the welded complex of the container.

### Solution to Problem

The present invention overcomes the aforementioned problem by providing a method of manufacturing containers from polymeric materials with unwarped internal partition. According to some aspects and embodiments of the present invention, a method of manufacturing containers from polymeric materials with unwarped internal partition comprises the steps of: premanufacturing a bottom plate-like part, premanufacturing a top part, including sidewalls with at least one interior monolithic partition extending in-between, applying a preheating procedure to the bottom part, appending the top part to the bottom part, preforming ultrasonic welding between the top part to the bottom part and cooling down the container.

One of the characteristics of the manufacturing method according to some aspects and embodiments of the present invention is the preheating of the bottom part, which facilitates the even and unwarped shape of the internal partition part of the top part. In other words, some aspects and embodiments of the present invention are characterized in that the preheated bottom part is used prior to the welding, to achieve a straightened out internal partition of the part of the two-part container.

In some embodiments of the manufacturing process presented herein, a heat source was used for preheating the bottom part prior to the step of ultrasonic welding. The step of preheating the bottom part has proved to prevent warpage of the in internal monolithic partition, which has occurred after applying ultrasonic welding followed by a step of cooling, in the containers welded without preheating of the bottom part. Any suitable heat source, such as: electrical, optical, etc., can be used

### Advantageous Effects of Invention

The advantageous effect of embodiments of the present invention is the preventing of warpage in the internal monolithic partition of the two-part container, manufactured from polymeric materials, by a means of welding the top part to the bottom part. The aforementioned advantageous effect is attributed to the step of preheating the bottom part, which reduces the possible internal stress of the internal monolithic partition, which occurs sometime after the ultrasonic welding and cooling down.

In some embodiments of the manufacturing method presented herein, the unexpected experimental effect of the preheating step has been the undefaced polymer container with a flat and straightened or otherwise unwarped internal partition in the top part of the container, after ultrasonic welding, coiling and retrieval. This is as opposed to the common manufacturing processes that are performed without preheating, which resulted in a warped and non-straight or buckled internal partition in the top part of the container, sometime after the ultrasonic welding, coiling and retrieval.

### Definitions

The terms preheating treatment as used herein includes not only a direct and/or indirect individual heat treatment, in which the bottom plate of the container is directly heated by applying thermal energy thereto but also an indirect heat treatment, in which the bottom plate is heated indirectly and/or remains a residual heat, after the injection molding thereof.

The term exterior profile as used herein refers inter alia to the bottom plate of the container. The exterior profile of the bottom plate is defined as a peripheral lateral surface of the bottom plate and/or peripheral edge on the top or bottom edge surrounding the bottom plate.

The term warpage as used herein relates to a physical deformation or distortion or twist or curvature in one or more directions of the structure of a molded internal partition in the top polymeric part. The internal partition in the top polymeric part loses its straight-line configuration as the result of warpage.

The term warped as used herein refers to a state in which a polymeric part surface is in a non-flat and/or non-straight and/or non-planar shape and/or non-plane shape, as a result warpage occurring sometime of after applying ultrasonic welding cooling.

The term unwarped as used herein is refers to a flattened and/or straightened and/or planar state of the surface of the internal partition.

The term modular, as referred to herein, should be construed as a stand-alone unit. The term modular inter alia means a standardized unit that may be conveniently installed or deployed without significant impact to the environment. The term modular, however, doesn't necessarily means providing for ease of interchange or replacement. The term modular is optionally satisfied by providing for ease of at least onetime deployment or installation.

The term readily connectable, as referred to herein, should be construed as a standardized unit that may be conveniently connected to other components of the system. The term readily connectable, however, doesn't necessarily means readily disconnectable or removable. The term readily connectable is optionally satisfied by providing for ease of at least onetime connection or coupling.

The terms matching and/or matchable as referred to herein is to be construed as a cross-sectional area and/or shape of a component is equal or essentially similar to a cross-sectional area and/or shape of another component. It should be acknowledged that the component need only to be similar in the cross-sectional areas and/or shapes, to satisfy the term matching/matchable, so long as the cross-sectional areas can be mated or the combination will fit into and/or occupy essentially the same lateral space.

The term structured as referred to herein is to be construed as including any geometrical shape, exceeding in complexity a plain linear shape or a shape embodying simple cylindrical, elliptical or polygonal contour or profile. A more complex shape, a plain linear shape or a shape embodying simple cylindrical, elliptical or polygonal contour or profile, constitutes an example of structured geometry.

The terms firm rigid or stiff, as referred to herein, are to be construed as having rigidity modulus value, otherwise referred to as the shear modulus, of 4800 MPa or more. Materials are considered to be firm rigid, or stiff but not tensile, when such materials are incapable of being efficiently elastically flexed or bent. Stiff materials, such as steel, are defined as having rigidity modulus value well exceeding 4800 MPa.

The terms pliable or pliant, as referred to herein, are to be construed as having high tensile strength and capable of being efficiently elastically flexed or bent but not being resilient and incapable of being efficiently stretched or expanded. The term tensile or tensile strength, as referred to herein, is to be construed inter alia as a shortcut of the known term ultimate tensile strength, frequently represented acronym as UTS, meaning an intensive property of a material or structure to withstand loads tending to elongate, namely to resist tension, defined as the maximum stress that a material can withstand while been stretched or pulled before sustaining breaking, substantial deformation and/or necking before fracture, such as nylon, relating to essentially non-ductile materials, having UTS value ranging between about 600 and 1000 MPa or more, but not including rigid, firm or stiff materials.

By operationally connected and/or operably coupled, as used herein, is meant connected in a specific way (e.g., in a manner allowing water to move and/or electric power to be transmitted) that allows the disclosed system and its various components to operate effectively in the manner described herein.

In the specification or claims herein, any term signifying an action or operation, such as: a verb, whether in base form or any tense, gerund or present/past participle, is not to be construed as necessarily to be actually performed but rather in a constructive manner, namely as to be performed merely optionally or potentially.

The term substantially as used herein is a broad term, and is to be given its ordinary and customary meaning to a person of ordinary skill in the art (and is not to be limited to a special or customized meaning), and refers without limitation to being largely but not necessarily entirely of that quantity or quality which is specified.

The term essentially means that the composition, method or structure may include additional ingredients, stages and or parts, but only if the additional ingredients, the stages and/or the parts do not materially alter the basic and new characteristics of the composition, method or structure claimed.

As used herein, the term essentially changes a specific meaning, meaning an interval of plus or minus ten percent (±10%). For any embodiments disclosed herein, any disclosure of a particular value, in some alternative embodiments, is to be understood as disclosing an interval approximately or about equal to that particular value (i.e., ±10%).

As used herein, the terms about or approximately modify a particular value, by referring to a range equal to the particular value, plus or minus twenty percent (+/−20%). For any of the embodiments, disclosed herein, any disclosure of a particular value, can, in various alternate embodiments, also be understood as a disclosure of a range equal to about that particular value (i.e. +/−20%).

As used herein, the term or is an inclusive or operator, equivalent to the term and/or, unless the context clearly dictates otherwise; whereas the term and as used herein is also the alternative operator equivalent to the term and/or, unless the context clearly dictates otherwise.

It should be understood, however, that neither the briefly synopsized summary nor particular definitions hereinabove are not to limit interpretation of the invention to the specific forms and examples but rather on the contrary are to cover all modifications, equivalents and alternatives falling within the scope of the invention.

### DESCRIPTION OF THE DRAWINGS

The present invention will be understood and appreciated more comprehensively from the following detailed description taken in conjunction with the appended drawings in which:

FIG. 1A is a perspective view of an embodiment of the components of the container, in an exploded conformation;

FIG. 1B is a perspective view of an embodiment of the container, in an assembled conformation;

FIG. 2A is a top view of an embodiment of the bottom part;

FIG. 2B is a bottom view of an embodiment of the bottom part;

FIG. 3A is a perspective view of an embodiment of the top part of the container;

FIG. 3B is a bottom view of an embodiment of the top part of the container;

FIG. 3C is a top view of an embodiment of the top part of the container;

FIG. 4A is an isometric view of another embodiment of the top part;

FIG. 4B is a is a front view of the longitudinal sidewall of another embodiment of the top part;

FIG. 5A is an isometric view of yet another embodiment of the top part;

FIG. 5B is a left-side view of the flanking sidewall of yet another embodiment of the top part;

FIG. 6A an isometric view of still another embodiment of the top part;

FIG. 6B an isometric view illustrating still another top embodiment of the part being appended to the bottom part;

FIG. 7 is a flowchart diagram illustrating an embodiment of the process for manufacturing containers from polymeric materials with unwarped internal partition;

FIG. 8 is a schematic block diagram of an embodiment of the system for manufacturing containers with unwarped internal partition from polymeric materials.

While the invention is susceptible to various modifications and alternative forms, specific embodiments thereof have been shown merely by way of example in the drawings. The drawings are not necessarily complete and components are not essentially to scale; emphasis instead being placed upon clearly illustrating the principles underlying the present invention.

### DETAILED DISCLOSURE OF EMBODIMENTS

Illustrative embodiments of the invention are described below. In the interest of clarity, not all features of actual implementation are described in this specification. It should be appreciated that various features or elements described in the context of some embodiment may be interchangeable with features or elements of any other embodiment described in the specification. Moreover, it will be appreciated that for the development of any actual embodiment, numerous implementation-specific decisions must be made to achieve the developers' specific goals, such as compliance with technology- or business-related constraints, which may vary from one implementation to another, and the effort of such a development might be complex and time-consuming, but would nevertheless be a routine undertaking for those of ordinary skill in the art having the benefit of this disclosure.

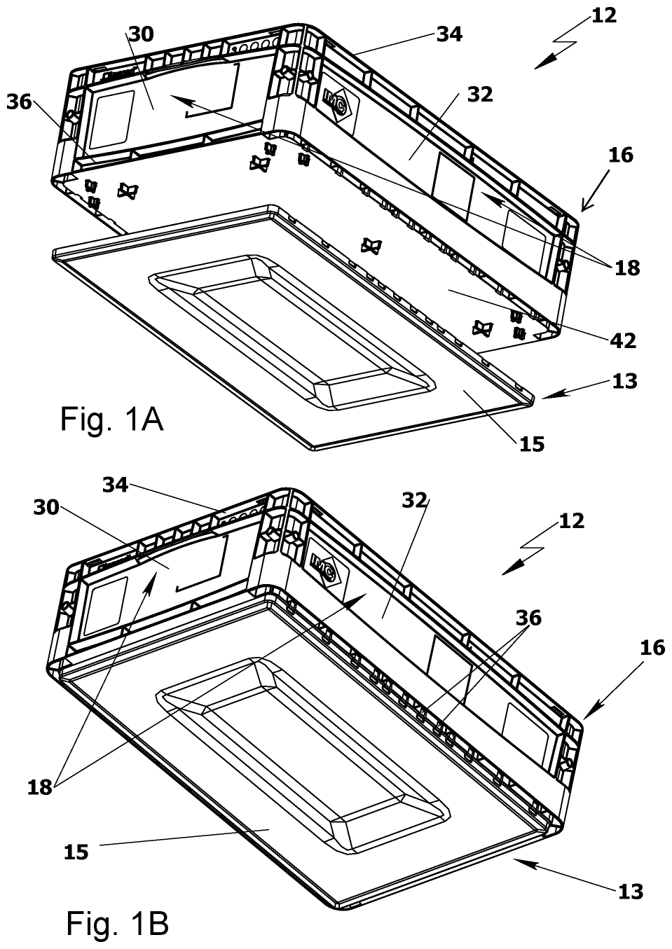

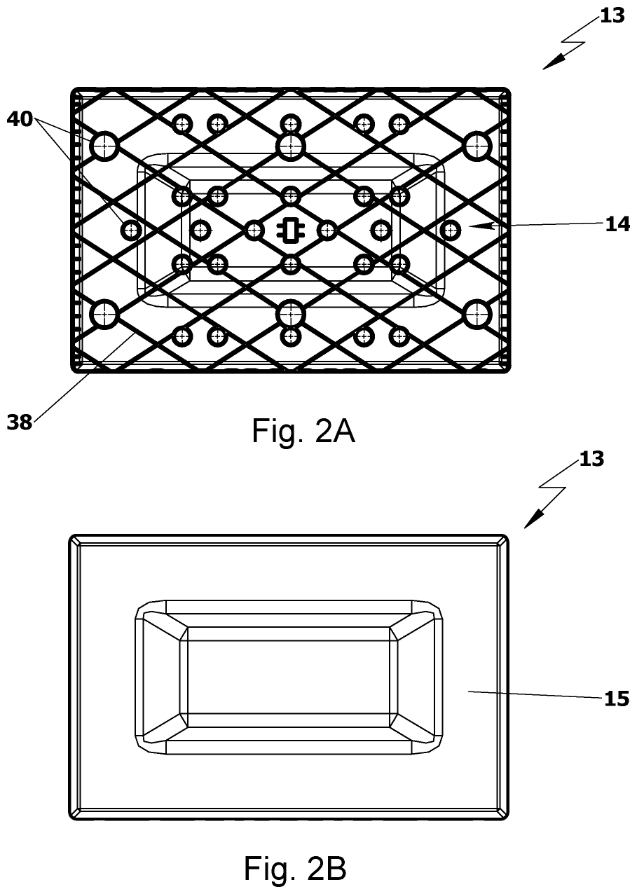

In accordance with some aspects and embodiments of the present invention, reference is now made to FIGS. 1A and 1B, showing container 12, as well as to FIGS. 2A and 2B, showing bottom part 13. Container 12 is typically configured for transporting fluidic and/or solid products. In some examples, container 12 is configurable in various sizes and/or volumes. In other examples, container 12 is portioned into different interior compartments. In some embodiments, container 12 is open from the top, namely with or without top plate or lid, whereas in other embodiments, container 12 is open from at least one sidewall of the container.

In some embodiments, container 12 comprises bottom part 13, shown in FIGS. 2A and 2B. Bottom part 13 is configured for bearing the weight of articles in container 12. In some examples, bottom part 13 comprises at least one polymeric material, such as polypropylene, polyethylene and particularly high density polyethylene, polysulfone, polyethersulfone, polyetherketone, polyetheretherketone, aromatic polyamide, aromatic polyester, aromatic polycarbonate, polyetherimide, polyarylene oxide, thermoplastic polyimide, polyamide, polyamideimide, or a combination of these polymeric materials.

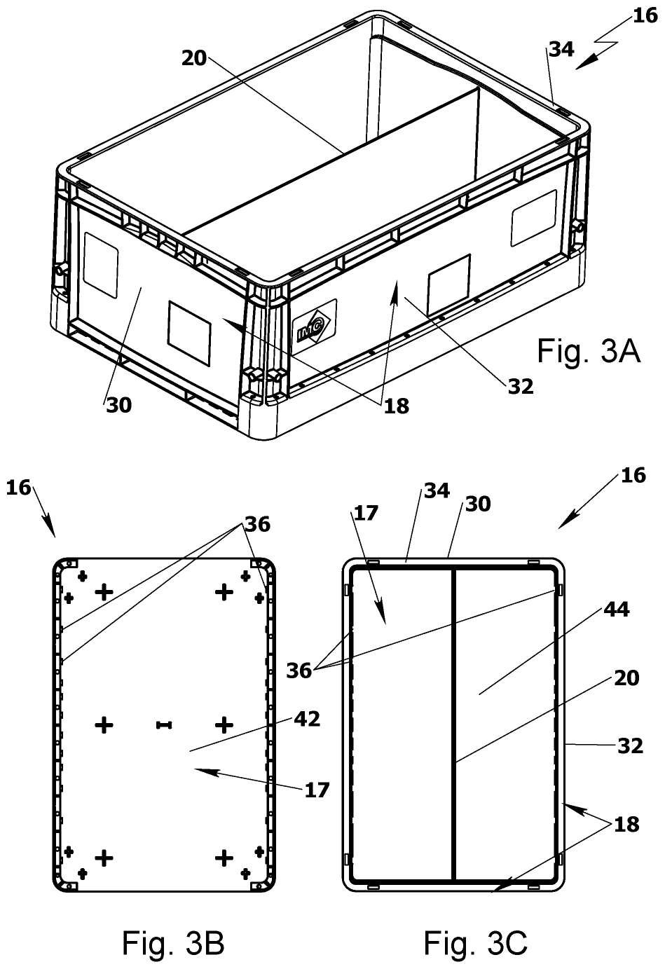

In some embodiments, container 12 comprises top part 16. In some embodiments top part 16 embodies different sizes and/or heights, for instance as shown in FIG. 3A to 3C. Top part 16 is configured for confining the articles in container 12 to the exterior profile of bottom part 13. In some examples, top part 16 comprises at least one polymeric material, such as polypropylene, polyethylene and particularly high density polyethylene, polysulfone, polyethersulfone, polyetherketone, polyetheretherketone, aromatic polyamide, aromatic polyester, aromatic polycarbonate, polyetherimide, polyarylene oxide, thermoplastic polyimide, polyamide, polyamideimide, or a combination of these polymeric materials.09-5se

In some examples, top part 16 comprises at least one polymeric material that is different than the polymeric material of bottom part 13. Whereas in other examples, top part 16 comprises at least one polymeric material that is essentially similar or identical to the polymeric material of bottom part 13.

In some embodiments, top part 16 optionally comprises bottom plate 17, shown in FIG. 3A to 3C. In some examples, bottom plate 17 is configured for providing additional support to container 12 to bear high weight articles. In some examples, bottom plate 17 is configure to match bottom part 13 of container 12. In some examples, bottom plate 17 is configured to form a continuum with at least one sidewall of container 12.

In some embodiments, top part 16 comprises plurality of surrounding sidewalls 18, shown in FIG. 3A to 3C. In some embodiments, the exterior profile of surrounding sidewalls 18 is configured to match the exterior profile of bottom part 13. In some embodiments, the interior profile of surrounding sidewalls 18 is configured to match the exterior profile of bottom part 13.

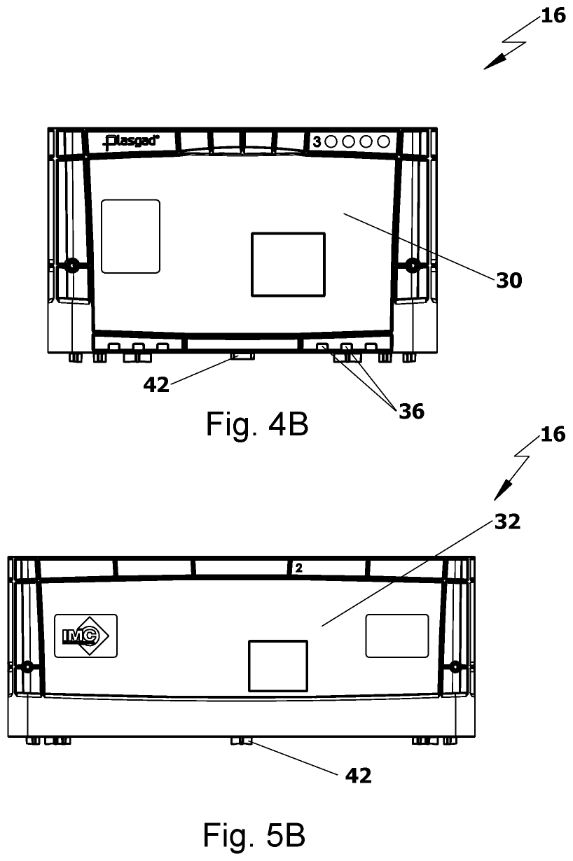

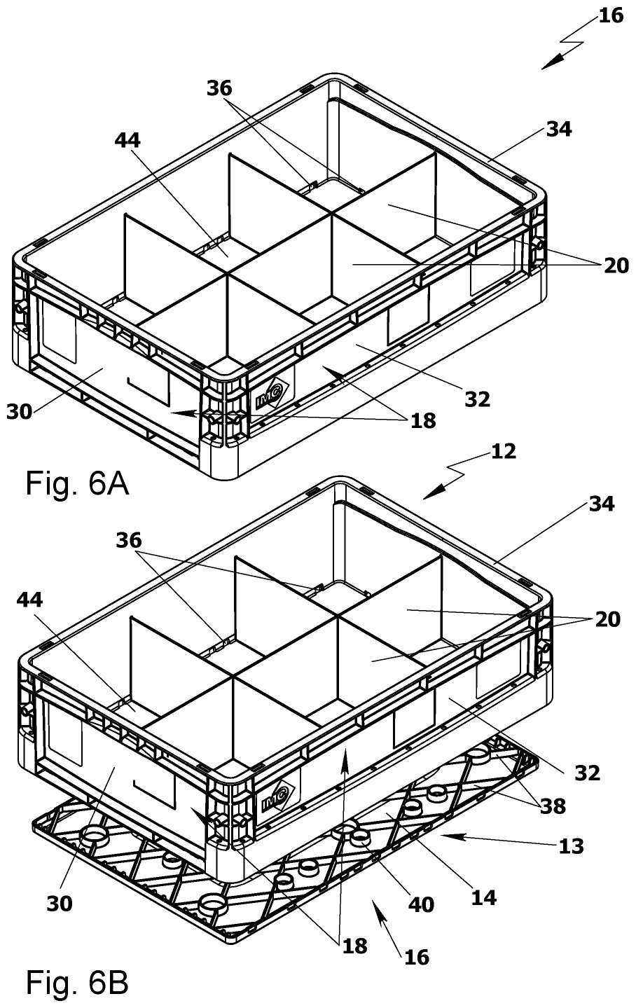

In some embodiments, surrounding sidewalls 18 comprise solid or ventilated sidewalls or a combination thereof. In some embodiments, surrounding sidewalls 18 are configurable in various heights such as shown in FIGS. 5A and 5B as well as in FIGS. 6A and 6B. In some embodiments, surrounding sidewalls 18 comprise pair of flanking sidewalls 30 and pair of longitudinal sidewalls 32.

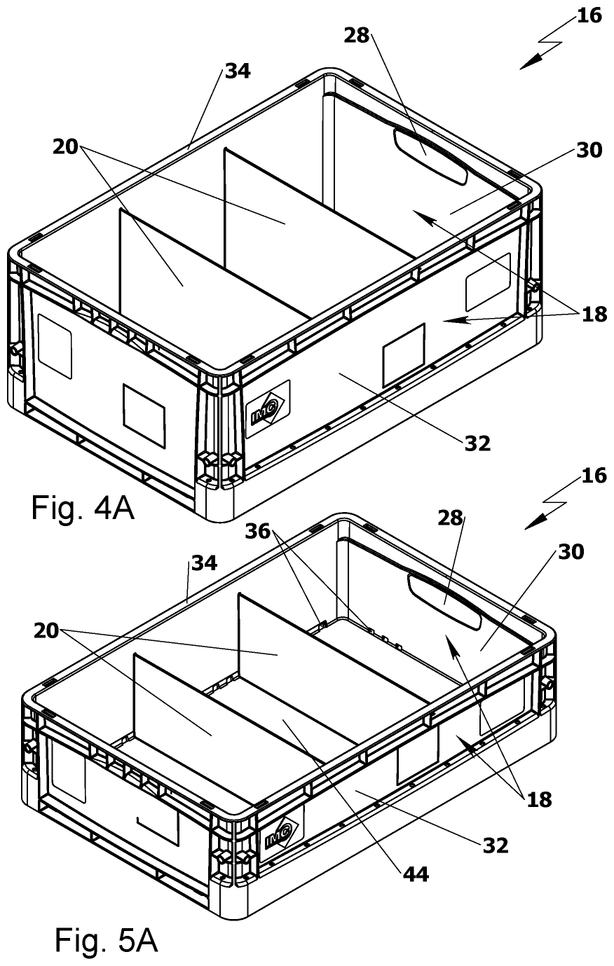

In some embodiments, top part 16, shown in FIG. 3A to 3C, comprises at least one interior partition 20. Interior partition 20 is configured for dividing the interior volume of container 12 into at least two distinct compartments as shown in FIG. 4A to 6B. Interior partition 20 extends essentially an entire distance in-between two opposing sidewalls of the plurality of surrounding sidewalls 18. In some embodiments, interior partition 20 is disposed widthwise, namely extending in-between pair of longitudinal sidewalls 32 as shown in FIG. 5A to 6B, whereas in other embodiments, interior partition 20 is disposed lengthwise, namely in-between pair of flanking sidewalls 30, as shown in FIGS. 6A and 6B. Interior partition 20 forms an integral part of plurality of surrounding sidewalls 18. Interior partition 20 is preferably monolithic with plurality of surrounding sidewalls 18.

In some examples, container 12 comprises a lid. The lid is configured for protecting, securing and/or sealing products inside container 12. The lid is configured for covering the open upper end of container 12. In some embodiments, the lid is configured for being removed easily. In another embodiments, the lid is configured for being tightly secured. In some examples, the lid is attachable to surrounding sidewalls 18 by interlocking, snap-on or hinged mechanism. In some examples, container 12 is configured for closing and/or stacking with the lid on top. In some examples, the lid is a folding split lid. In another embodiment, container 12 is configured for a single use or for multiple uses.

In some examples, bottom part 13 of container 12 comprises wheels. The wheels are configured for facilitating the transportation of container 12. In some embodiments, the wheels comprise at least one material, such as polymer or metal or a combination of these. In some examples, the wheels are removably attachable to bottom part 13.

In some embodiments, at least one surrounding sidewall 18, such as flanking sidewalls 30 and/or longitudinal sidewalls 32, comprise at least one of: a handle, tab-shaped handhole 28, a preparation for a handhole and a combination thereof. The handle and/or handhole 28, as shown in FIGS. 4A and 5A are configured for manually carrying and/or manipulating container 12. In some examples, the handle extends outwardly from surrounding sidewall 18, namely from at least one of flanking sidewalls 30 and/or longitudinal sidewalls 32. In some embodiments, at least one handle or handhole 28 is located on flanking sidewalls 30. In other embodiments, at least one handle or handhole 28 is located on longitudinal sidewalls 32.

In some embodiments, surrounding sidewalls 18 comprise peripheral rim 34, as shown in FIGS. 4A and 5A. In some embodiments, rim 34 is configured for at least: stacking of container 12 on top of another of container 12, positioning of the lid on top of container 12, suspending of container 12 by disposing rim 34 onto rails (not shown) or a combination thereof. Rim 34 is preferably configured for manipulating container 12 on a robotic railway and/or conveyor, as well as for conveying and/or positioning container 12 inside an automated warehouse.

In some embodiments, surrounding sidewalls 18 comprise at least one ventilation hole 36. Ventilation hole 36 is configured for air circulation and odor removal. In some embodiments, ventilation hole 36 is typically located in the bottom edge of surrounding sidewalls 18 as shown in FIG. 1B. In some embodiments, ventilation hole 36 is a round and/or polygonal hole or a combination of both.

In some example, bottom part 13 comprises structured superior surface 14, as shown in FIG. 2A. Superior surface 14 of bottom part 13 is configured for engaging and aligning with bottom plate 17 of top part 16, and for strengthening of container 12. In some embodiments, superior surface 14 of bottom part 13 comprises a plurality of reinforced ribs 38 of circular and/or polygonal shapes 40 as shown in FIG. 2A. In some embodiments, bottom part 13 comprises structured inferior surface 15, as shown in FIG. 2B. In some embodiments, inferior surface 15 of bottom plate 13 is configured for providing a firm grip of container 12 on a ground.

In some embodiments, bottom plate 17 of top part 16 comprises structured inferior surface 42, as shown in FIG. 3B. Inferior surface 42 of bottom plate 17 is configured for engaging and/or aligning with superior surface 14 of bottom part 13, as shown in FIG. 2A. In some embodiment, inferior surface 42 of bottom plate 17 comprises at least one polygonal and/or circular and/or cross shaped structural protrusion or a combination thereof, which is fitted into circular and/or polygonal shapes 40 of superior surface 14 of bottom part 13, as shown in FIG. 2A.

In some embodiments, bottom plate 17 comprises superior surface 44, as shown in FIG. 3C. Superior surface 44 of bottom plate 17 is configured to affix or otherwise contact with articles in container 12. For example, superior surface 44 of bottom plate 17 optionally includes a plain, structured, textured and/or furrowed surface.

In another embodiment, top part 16 comprises surrounding side walls 18 and at least one interior partition 20, without bottom plate 17. In such embodiments, top part 16 is configured for matching with exterior profile of bottom part 13. In such embodiments, superior surface 14 of bottom part 13 is configured to affix or otherwise contact articles in container 12. For example, superior surface 14 of bottom part 13 optionally includes a plain, structured, textured and/or furrowed surface.

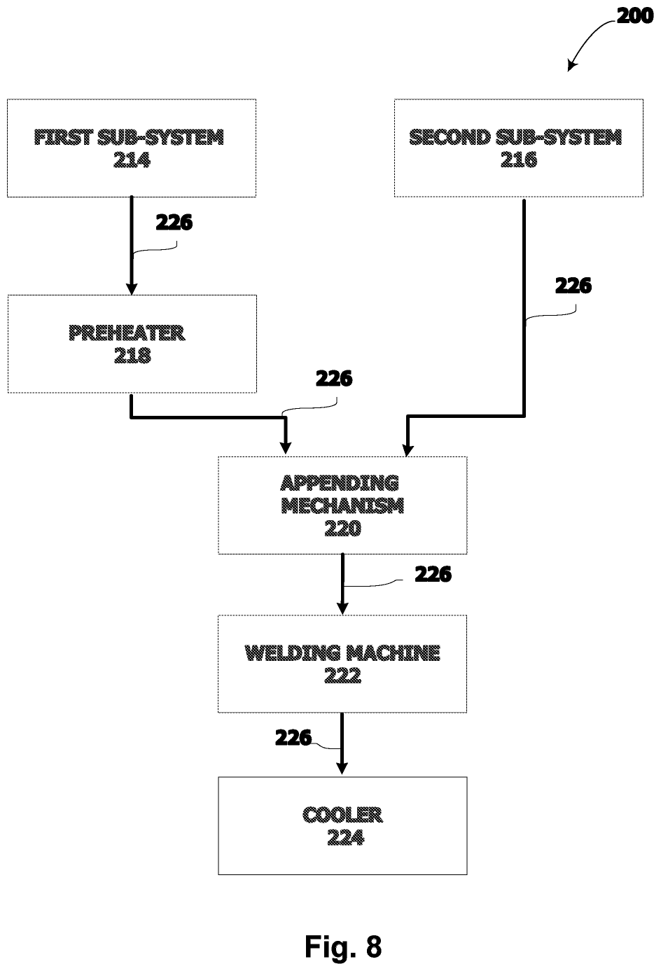

In accordance with some embodiments of the present invention, reference is now made to FIG. 8, showing a schematic block diagram of system 200 for manufacturing containers with unwarped internal partition from polymeric materials. In some embodiments, system 200 for manufacturing containers with unwarped internal partition of the embodiment of FIG. 8 illustrates various features that may be interchangeable with elements of any other embodiment described in the specification.

In some embodiments, system 200 includes at least one first premanufacturing subsystem 214. First premanufacturing subsystem 214 is configured for producing a bottom plate part of the container, such as bottom part 13 of container 12 shown in FIG. 2A.

In some examples, first premanufacturing subsystem 214 comprises at least one of the plastic processing machines for producing polymeric products, in a non-limiting manner including: an extruder, injection molding machine, thermo-forming machine, vacuum-forming machine, pressure-forming machine or any combination of these processing machines. In some embodiments, first premanufacturing subsystem 214 comprises an extruder including at least one constituent selected from: a feed hopper, extruder barrel, extruder screw, extruder drive, extrusion discharge or die system, heating/cooling system and safety and control facilities.

In some embodiments, first premanufacturing subsystem 214 comprises an extruder including at least one constituent selected from: a water bath or spray chamber to cool the extruded shape, vacuum sizing tank to maintain wall thickness and sizing of the product as it passes through the machine, cleated belt pullers configured to apply smooth tension on the product and keep it moving in pace with the extruder and an automatic cutting or sawing unit to create the final product length.

In some embodiments, first premanufacturing subsystem 214 comprises an injection molding machine, configured for making plastic parts using two-part molds. In such embodiments, when the two-part mold is closed, a melted plastic resin is injected into individual parts of the mold. In some embodiments, an injection molding machine includes injection and clamping units. In some examples, an injection unit comprises at least one constituent selected from: hopper, screw, heaters, drive and gearing unit, barrel and nozzle. In some examples, a clamping unit comprises at least one constituent selected from: stationary and movable platens, molds, tie rods, clamping and hydraulic cylinders.

In some embodiments, first premanufacturing subsystem 214 comprises a thermoforming machine. In some examples, a thermoforming machine comprises at least one constituent selected from: a heater, molds, pick-up platform, heating platen assembly, feeder, cutting device. In some examples, first premanufacturing subsystem 214 comprises a vacuum-forming machine including at least one constituent selected from: a heater, toggle clamp, molds, platen, lift handle, lift linkage, vacuum pump, fans and/or cool mist and trimer. In some embodiments, a pressure forming machine includes a group consisting of: heater, pressure box, toggle clamp, molds, platen, lift handle, lift linkage, vacuum pump, fans and/or cool mist and trim. In some embodiments, the molds, extruder die and nozzles is used by at least one of the plastic processing machines embody an inverted shape of a bottom plate-like part of a container.

In some embodiments, system 200 includes at least one second premanufacturing subsystem 216. Second premanufacturing subsystem 216 is configured for producing the top part of the container. In some example, second premanufacturing subsystem 216 comprises at least one member selected from the group consisting of: a mold of a top part of the container and an extruder nozzle of the top part of the container. In some examples, second premanufacturing subsystem 216 is at least one of the plastic processing machines for producing polymeric products such as an extruder, an injection molding machine, thermo forming, vacuum-forming or pressure-forming machine or a combination of these processing machines. In some examples, the molds, extruder die and nozzles is used by at least one of the plastic processing machines embody an inverted shape of at least one of the top part member of container, such as surrounding sidewalls, with the monolithic interior partition.

In some embodiments, the bottom and top parts, manufactured by subsystems 214 and 216 are transported by conveying mechanism 226. In some embodiments, bottom and top parts are manufactured in a co-manufacturing facility. In some examples, conveying mechanism 226 includes at least one transporting mechanism, such as conveyor, robotic arm, mobile robots, vehicles, or a combination of these. In some embodiments, bottom and top parts are manufactured in different manufacturing facilities. In some examples, conveying mechanism 226 from one facility to another includes at least one external transport forms such as trucks, trains, airplanes, ships, cars or a combination thereof.

In some embodiments, system 200 includes preheater 218. Preheater 218 is configured for applying preheating treatment to bottom part, to a temperature ranging from 40 to 240 degrees Celsius for the duration ranging between 20 seconds to several minutes. In some examples, preheater 218 comprises at least one of the typical heating mechanisms such as electric, ceramic infrared heaters, gas burner, gas water heater or a combination thereof.

In some embodiments, system 200 includes appending mechanism 220. Appending mechanism 220 configured for appending top part to preheated bottom part of the container. In some examples, appending mechanism 220 comprises at least one manipulator dedicated for the bottom part and/or at least one manipulator dedicated for the top part. In some examples, appending mechanism 220 includes robotic arms, conveyor, etc.

In some embodiments, system 200 includes welding machine 222. Welding machine 222 is configured for fusing the interior edge at the bottom of the top part with an exterior edge at the top of the bottom part, thereby forming a welded complex of the container. In some embodiments, welding machine 222 implements at least one welding method selected from the group consisting of: ultrasonic welding, spin welding, vibration welding, hot plate welding, hot gas welding, friction welding, frequency welding, infrared welding, laser welding or a combination thereof.

In some embodiments, system 200 includes cooler 224. Cooler 224 is configured to solidify the newly formed bonds of welded complex of the container, thereby stretching at least one interior partition and facilitating the formation of an unwarped internal partition. In some examples, cooler 224 implements at least one cooling down process selected from the group consisting of: air-cooling, water-cooling, room temperature circulation or a combination thereof.

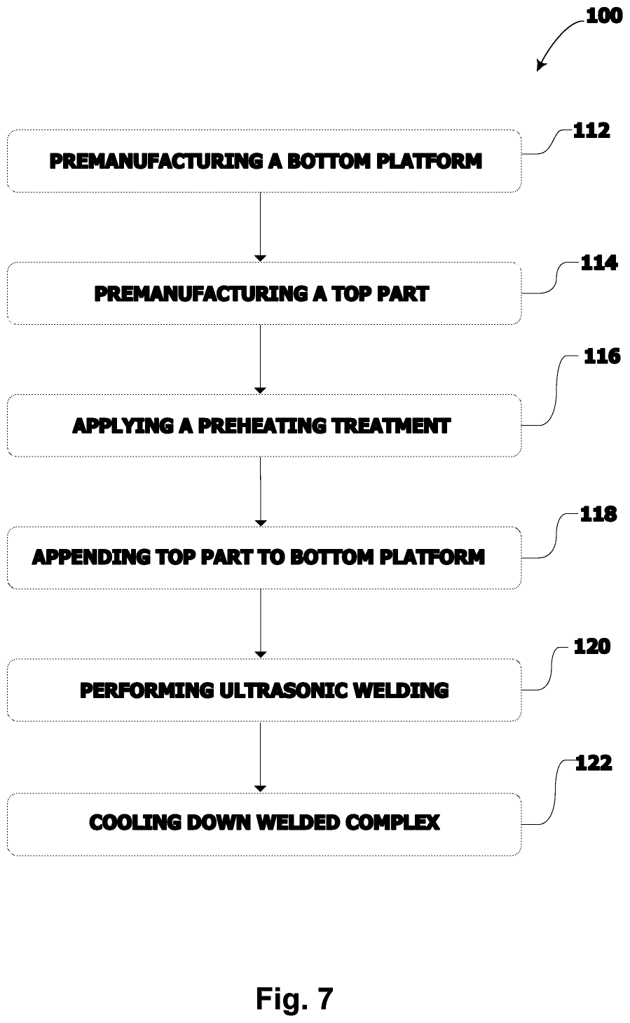

In accordance with some aspects of the present invention, reference is now made to FIG. 7, showing high-level flowchart 100 of an exemplary process of manufacturing containers from polymeric materials with unwarped internal partition. In some embodiments, process 100 of manufacturing containers with unwarped internal partition of the embodiment of FIG. 7 illustrates various features that may be interchangeable with elements of any other embodiment described in the specification.

In some embodiments, a process of manufacturing containers with unwarped internal partition of flowchart 100 commences at step 112, of premanufacturing a first subpart, typically the bottom plate, such as bottom part 13 of container 12 shown in FIG. 2A. In some examples, step 112, of premanufacturing a first subpart, comprises injection molding. Exemplary injection molding of step 112 is performed by a first premanufacturing subsystem, such as first premanufacturing subsystem 214 of system 200 shown in FIG. 8.

In some examples step 112, of premanufacturing a first subpart, comprises melting plastic resin, by heating the resin to a predetermined temperature, applying pressure to the melted plastic resin and then injecting the melted plastic into at least one mold embodying an inverted shape of a bottom part of the container. In some embodiments, step 112, of premanufacturing a first subpart, utilizes recycled resin pellets from a waste plastic recycling machine.

In some embodiments, a process of manufacturing containers with unwarped internal partition of flowchart 100 comprises step 114, of premanufacturing a second subpart, typically the top part, such as top part 16, with bottom plate 17, surrounding sidewalls 18 and at least one interior partition 20 of container 12 shown in FIG. 3A. In some examples, step 114, of premanufacturing a second subpart, comprises injection molding. Exemplary injection molding of step 114 is performed by a second premanufacturing subsystem, such as second premanufacturing subsystem 216 of system 200 shown in FIG. 8.

In some examples step 114, of premanufacturing a second subpart, comprises melting plastic resin, by heating the resin to a predetermined temperature, applying pressure to the melted plastic resin and then injecting the melted plastic into at least one mold embodying an inverted shape of a top part of the container. In some embodiments, step 114, of premanufacturing a second subpart, utilizes recycled resin pellets from a waste plastic recycling machine.

In some embodiments, a process of manufacturing containers with unwarped internal partition of flowchart 100 comprises step 116, of applying a preheating treatment to the bottom part. In some examples, step 116, of applying a preheating treatment to bottom part, comprises heating by a heater, such as electric heater 218 of system 200 shown in FIG. 8. In some examples, step 116, of applying a preheating treatment to the bottom part, comprises transporting the bottom parts and the top parts, preheating of the bottom parts, by elevating temperature to 40 to 240 degrees Celsius and applying heating treatment to partially or entirely bottom part from 20 seconds to several minutes.

In some embodiments, a process of manufacturing containers with unwarped internal partition of flowchart 100 comprises step 118, of appending the top part of container to the bottom part following step 116 of applying preheating. In some examples, step 118, of appending the top part of container to the bottom plate, is performed by an appending machine, such as robotic arm 220 shown in FIG. 8. In some examples step 118, of appending the top part of container to the bottom plate, comprises loading bottom part and top part on the appending machine.

In some embodiments, the process of manufacturing containers with unwarped internal partition of flowchart 100 comprises step 120, of performing welding, between a bottom edge of top part and a top face of the bottom part. In some examples, step 120 is configured for forming a welded complex of container, as shown in FIG. 1B. In some examples, step 120 is performed by a welding machine, such as ultrasonic welding machine 222 shown in FIG. 8.

In some examples, step 120, of performing welding, between a bottom edge of top part and a top face of bottom part, comprises assembling and fixturing the bottom edge of top part to the top face of bottom part, such as by pressuring and heating by the welding machine, at the frequency ranging between 25 to 750 Hz, welding and then holding the parts for the duration ganginh between 2 seconds to 50 seconds to allow them to fuse into the welded complex of the container.

In some embodiments, a process of flowchart 100 comprises step 122, of cooling down the welded complex of the container. In some examples, step 122 is configured for stretching at least one interior partition and facilitating forming of an unwarped internal partition. In some examples, step 122 is performed by a cooler, such as air-cooler system 224 shown in FIG. 8. In some embodiments, step 122 of cooling down the welded complex of the container, comprises removing the welded complex of container from welding machine and passively applying a room temperature of about 25-35 degrees Celsius.

### WORKING EXAMPLES

### Working Example 1

First working example of the container with unwarped internal partition of the present invention is next described. The container was of the configuration shown in FIG. 3A that included surrounding sidewalls with dimensions of 600 mm length, 400 mm width and 240 mm height. In the configuration shown in FIG. 3A, one interior partition was disposed lengthwise, in-between the pair of the flanking sidewalls. The typical thickness of surrounding sidewalls and of the interior partition about is 2.6 mm. The width of surrounding sidewalls including rim was 13.2 mm to 13.5 mm. The dimensions of the bottom part were 564.2 mm length, 366.2 mm width, and 13.4 mm height. The thickness of the bottom part was 2.5 mm. The bottom part and top part were composed of 98.3% PP TG50, 1% Grey dye and 0.7% UV stabilizer.

### Working Example 2

Second working example of the container with unwarped internal partition of the present exemplary embodiment is next described. The container was of the configuration shown in FIG. 4A that included surrounding sidewalls with dimensions of 600 mm length, 400 mm width and 240 mm height. In the configuration shown in FIG. 4A, two interior partitions are disposed widthwise, in-between the pair of the longitudinal sidewalls. The typical thickness of surrounding sidewalls and of the interior partition was 2.6 mm. The width of surrounding sidewalls including the rim was 13.2 mm-13.5 mm. The dimensions of bottom part were 564.2 mm length, 366.2 mm width, and 13.4 mm height. The typical thickness of the bottom part was 2.5 mm. The bottom part and top part were composed of 98.3% PP TG50, 1% Grey dye and 0.7% UV stabilizer.

### Working Example 3

Third working example of the container with unwarped internal partition of the present exemplary embodiment is next described. The preheater used for applying the preheating treatment to bottom part was a heating oven available from GALATEK a.s. at Na Pláckách 647, 584 01 Ledec̆ nad Sázavou Czech republic. The welding machine used for fusing a bottom edge of top part with a top face of bottom part was a vibration welding machine available from CEMAS Elettra S.r.l. at Strada degli Occhini, 23. 10022 Carmagnola (TO) Italy.

The process of manufacturing the container from polymeric materials with unwarped internal partition according to the present working example included preheating to a temperature of 70 degrees Celsius for 45 seconds, preforming welding, between a bottom edge of top part and a top face of bottom part, applying vibration for of 5.6 seconds, at the frequency of 213 Hz and weld depth of 0.59 mm. Phases 1, 2 of welding were of duration of 2.5 seconds, a Kg force of 1200 Kg and an amplitude of 1.8 mm. The cooling down of the welded complex of the container was for 6 sec at a force of 1600 Kg.

### Working Example 4

Forth working example of the container with unwarped internal partition of the present exemplary embodiment is next described. The container shown in FIG. 5A is of a configuration that includes surrounding sidewalls 18 with dimensions of 600 mm length, 400 mm width and 170 mm height. In the configuration shown in FIG. 5A, two interior partitions are disposed widthwise, in-between the pair of the longitudinal sidewalls. The typical thickness of surrounding sidewalls and of the interior partition was 2.6 mm. The width of surrounding sidewalls including the rim was 13.2 mm-13.5 mm. The dimensions of bottom part were 564.2 mm length, 366.2 mm width, and 13.4 mm height. The typical thickness of the bottom part was 2.5 mm. The bottom part and top part were composed of 98.3% PP TG50, 1% Grey dye and 0.7% UV stabilizer.

### Working Example 5

Fifth working example of the container with unwarped internal partition of the present exemplary embodiment is next described. The container shown in FIG. 6A is of a configuration that includes surrounding sidewalls with dimensions of 600 mm length, 400 mm width and 170 mm height. In the configuration shown in FIG. 6A, two interior partitions were disposed widthwise, in-between the pair of longitudinal sidewalls and one interior partition was disposed lengthwise, in-between the pair of flanking sidewalls.

The typical thickness of surrounding sidewalls and of the interior partition was 2.6 mm. The width of surrounding sidewalls including the rim was 13.2 mm-13.5 mm. The dimensions of bottom part were 564.2 mm length, 366.2 mm width, and 13.4 mm height. The typical thickness of the bottom part was 2.5 mm. The bottom part and top part were composed of 98.3% PP TG50, 1% Grey dye and 0.7% UV stabilizer.

It will be appreciated by persons skilled in the art that the present invention is not limited by what has been particularly shown and described herein above. Rather the scope of the invention is defined by the claims which follow:

1. A process of manufacturing containers from polymeric materials with unwarped internal partition comprises:
(a) premanufacturing a bottom part of a container from a polymeric material, wherein said bottom part embodying essentially a platform shape;
(b) premanufacturing a top part of said container from a polymeric material, wherein said top part comprising:
(I) a bottom plate of said top part, configured to match said bottom part, wherein a superior surface of said bottom part is engageable to an inferior surface of said bottom plate of said top part;
(II) a plurality of surrounding sidewalls, wherein an interior profile of said surrounding sidewalls is configured to match an exterior profile of said bottom part;
(III) at least one interior partition, configured for dividing an interior volume of said container into at least two distinct compartments, wherein said interior partition extends essentially an entire distance in-between two opposing sidewalls, of said plurality of surrounding sidewalls, wherein said interior partition forms an integral monolithic part of said plurality of surrounding sidewalls;
(c) applying a preheating treatment to said bottom part;
(d) appending said top part of said container to said bottom part following said step of applying said preheating;
(e) welding said interior profile of said surrounding sidewalls of said top part with said exterior profile of said bottom part, thereby forming a welded complex of said container;
(f) cooling down said welded complex of said container, thereby facilitating stretching of said at least one interior partition and forming of a container with an unwarped internal partition.

2. The process as in claim 1, wherein said interior profile of said surrounding sidewalls is configured to overlap with said exterior profile of said bottom part.

3. The process as in claim 1, wherein said welding comprises an ultrasonic welding.

4. A container with unwarped internal partition, manufactured from polymeric materials, said container comprises:
(a) a bottom part of said container, wherein said bottom part embodying essentially a platform shape;
(b) a top part of said container, wherein said top part comprising:
(I) a bottom plate of said top part, configured to match said bottom part, wherein a superior surface of said bottom part is engageable to an inferior surface of said bottom plate of said top part;
(II) a plurality of surrounding sidewalls, wherein an interior profile of said surrounding sidewalls is configured to match an exterior profile of said bottom part;
(III) at least one interior partition, configured for dividing an interior volume of said container into at least two distinct compartments, wherein said interior partition extends essentially an entire distance in-between two opposing sidewalls, of said plurality of surrounding sidewalls, wherein said interior partition forms an integral monolithic part of said plurality of surrounding sidewalls;
said container is being manufactured by performing the steps of:
(c) premanufacturing said bottom part from a polymeric material;
(d) premanufacturing said top part from a polymeric material;
(e) applying a preheating treatment to said bottom part;
(f) appending said top part of said container to said bottom part following said step of applying said preheating;
(g) welding said interior profile of said surrounding sidewalls of said top part with said exterior profile of said bottom part, thereby forming a welded complex of said container;
(h) cooling down said welded complex of said container, thereby facilitating stretching of said at least one interior partition and forming of said container with said unwarped internal partition.

5. The container as in claim 4, wherein said container comprises a plurality of interior monocytic partitions.

6. The container as in claim 4, wherein said container is of at least one configuration selected from the group consisting of: an open top configuration, closed configuration, open side configuration and open front configuration.

7. The container as in claim 4, wherein said container comprises a plurality of interior monocytic partitions, wherein at least one partition of said plurality of interior monocytic partitions is disposed essentially orthogonally to at least one another partition of said plurality of interior monocytic partitions.

8. The container as in claim 4, wherein said surrounding sidewalls comprise a peripheral rim.

9. The container as in claim 4, wherein said bottom part comprises a superior surface, wherein said superior surface comprises a structured shape configured for engaging to inferior surface of said bottom plate of said top part.

10. The container as in claim 4, wherein said bottom part comprises at least one structural element selected from the group consisting of: a reinforcement rib, circular ridge and polygonal ridge.

11. The container as in claim 9, wherein said superior surface of said bottom plate of said top part comprises at least one structural element configured for affixing articles in said container.

12. The container as in claim 4, further comprises a lid, wherein said lid is attachable to said surrounding sidewalls by at least one mechanism selected from the group of: an interlocking mechanism, snap-on mechanism and hinged mechanism.

13. A system for manufacturing containers with unwarped internal partition from polymeric materials comprises:
(a) at least one first premanufacturing subsystem, comprising at least one mold embodying an inverted shape of a bottom part of said container;
(b) at least one second premanufacturing subsystem, comprising at least one member selected from the group consisting of: a mold embodying an inverted shape of a top part of said container and an extruder nozzle comprising a profile of a shape said top part of said container;
wherein said at least one member further comprises:
(I) a void volume of an inverted shape of surrounding sidewalls, wherein an interior profile of said surrounding sidewalls essentially matching an exterior profile of said bottom plate;
(II) a void volume of an inverted shape of at least one monolithic interior partition, configured for dividing an interior volume of said container into at least two distinct compartments;
wherein said interior partition extends essentially an entire distance in-between two opposing sidewalls, of said surrounding sidewalls;
wherein said void volume of said inverted shape of said at least one interior partition forms a continuum with said void volume of said inverted shape of said surrounding sidewalls;
(c) at least one preheater, configured to apply preheating treatment to said bottom part;
(d) an appending mechanism configured appending said top part of said container to a preheated bottom part;
(e) a welding machine, configured for fusing a bottom edge of said top part with a top edge of said bottom part, thereby forming a welded complex of said container;
(f) a cooler configured for cooling down said welded complex of said container, thereby stretching said at least one interior partition and facilitating forming of a container with an unwarped internal partition.

14. The system as in claim 13, wherein said interior profile of said surrounding sidewalls is configured to overlap with said exterior profile of said bottom part.

15. The system as in claim 13, wherein said welding machine comprises an ultrasonic welding machine.
